(19) United States
(12) Patent Application Publication
(10) Pub. No.: US 2006/0282371 A1
(43) Pub. Date: Dec. 14, 2006

(54) Methods and apparatus for analysis of opportunities for marketing and providing of mortgage services

(75) Inventors: Brian Doyle, Raleigh, NC (US); Erik D. Pollack, Durham, NC (US); Michael Homiak, Raleigh, NC (US); Mary Still, Raleigh, NC (US)

Correspondence Address: PRIEST & GOLDSTEIN PLLC, 5015 SOUTHPARK DRIVE, SUITE 230, DURHAM, NC, 27713-7736, US

(73) Assignee: GE Mortgage Holdings, LLC, Raleigh, NC (US)

(21) Appl. No.: 11/148,089

(22) Filed: Jun. 8, 2005

(51) Int. Cl. G06Q 40/00

(52) U.S. Cl. 705/38

(57) ABSTRACT

Systems and techniques for identifying and evaluating opportunities for marketing and providing mortgage services. Categories of demographic and economic data are identified that are required to provide specified information identifying comparative geographic regions and population groups with respect to opportunities they present for marketing and providing mortgage services. Arrangements are made to receive data as needed from one or more data sources supplying such data. Requirements specifying desired information are identified, and specific data and processing needed to generate information meeting the requirements is identified. The identified data is retrieved and processed and the information generated is formatted and presented.

### FIELD OF THE INVENTION

The present invention relates generally to improved techniques and systems for mortgage financing. More specifically, the invention relates to analysis and comparison of local factors and present and future conditions and the use of such analysis and comparison in allocating resources to marketing and providing mortgage services.

### BACKGROUND OF THE INVENTION

Mortgage financing is becoming an increasingly competitive industry. Many mortgage providers compete with one another to serve an increasingly sophisticated consumer base. In addition, one important segment of the mortgage industry, the refinancing segment, is subject to significant declines in demand, leading to an oversupply of providers and intense competitive pressures. During a period of declining interest rates, refinancing demand can be expected to be strong. Any time interest rates have declined significantly since a borrower last obtained a mortgage, the possibility is present that borrower can obtain an advantage from refinancing. In a period of stable or, especially, increasing interest rates, consumers tend to lose interest in refinancing because refinancing will not be expected to gain them a significant advantage. On the contrary, if mortgage rates have increased, initiating and concluding a refinancing transaction could prove very costly over both the short and long terms. When interest rate trends change from a decreasing trend to an increasing trend, mortgage providers which may have invested in substantial resources to serve high demand existing during a period of declining interest rates, and must then market and deploy their resources and services skillfully in order to use these resources to maximum advantage during periods of declining demand.

Different geographic areas and population groups exhibit different characteristics relevant to the focusing of mortgage marketing efforts. Many factors characteristic of a particular geographic area may be relevant to the potential demand and profitability of mortgage services at any given time. For example, an area with a strong and growing demand for housing can be expected to demand a significant level of mortgage services even if refinancing demand declines, and an area with high and growing employment can be expected to exhibit a relatively low rate of default.

Various factors relating to the overall population, or various population groups, of a given area or region, can yield insight into the targeted marketing and providing of mortgage services. For example, a population group may exhibit a potential need for mortgage services, such as a need and capability to purchase homes, that is greater than the level of services actually being used by the population group. Alternatively, a particular provider may be serving a population group at a lower rate than the rate of service being rendered of its competitors.

In addition, information may be available for specific geographic areas or population groups, or for the overall mortgage environment, from which projections of future conditions and trends can be made. Accurate projections of future conditions can be used to determine probable demand for and profitability of mortgage services, and can be used to make decisions related to the addition or removal of resources for marketing and providing of mortgage services.

### SUMMARY OF THE INVENTION

Among its several aspects, the present invention recognizes that there is a need for systems and approaches for collecting and examining information relevant to present and future demand for and profitability of mortgage services and for processing the information to determine suitable levels of resources to be devoted to marketing and providing mortgage services and to identify areas and population groups to which to direct targeted marketing and providing of mortgage services.

A system for identifying and evaluating opportunities for the marketing and providing of mortgage services may suitably comprise a control unit for identifying data needed to provide desired information relating to opportunities for marketing and providing mortgage services and identifying operations to be performed on that data in order to identify and evaluate opportunities for marketing and providing mortgage services. Such a system may further include a data collection and storage unit for retrieving data from one or more of a plurality of sources of demographic and economic data and storing the data using a data storage device and a processing unit for receiving data from the data collection and storage unit and processing the data to identify demographic and economic characteristics of regions and population groups and to evaluate the demographic and economic characteristics in order to generate opportunity evaluation information identifying and evaluating opportunities for marketing and providing of mortgage services.

A process of identifying and evaluating opportunities for marketing and providing of mortgage services may suitably comprise identifying categories of demographic and economic data required to provide desired.information identifying and evaluating geographic regions and population groups with respect to opportunities they present for marketing and providing mortgage services and arranging to receive data as needed from one or more data sources supplying such data. Upon receiving requirements specifying desired information to be generated, specific data needed to generate information meeting the requirements is identified. Processing to be performed on the data in order to generate the information is also identified. The identified data is retrieved and the identified processing is performed to generate the information meeting the requirements. The information is then formatted and presented.

A more complete understanding of the invention, as well as further features and advantages of the invention, will be apparent from the following Detailed Description and from the claims which follow below.

### BRIEF DESCRIPTION OF THE DRAWINGS

FIG. 1 illustrates a system for identifying and evaluating opportunities for marketing and providing mortgage services according to an aspect of the present invention;

FIG. 2 illustrates a process of identifying and evaluating opportunities for marketing and providing mortgage services according to an aspect of the present invention;

FIG. 3 illustrates comparative data for a selection of geographic areas;

FIG. 4 illustrates data comparing performance with respect to a specified population group against that of its peers in a selection of geographic areas;

FIG. 5 illustrates a process of identifying geographic areas of interest based on characteristics of a specified population group and

FIG. 6 illustrates comparative demographic and homeownership data for a population group in a selection of geographic areas.

### DETAILED DESCRIPTION

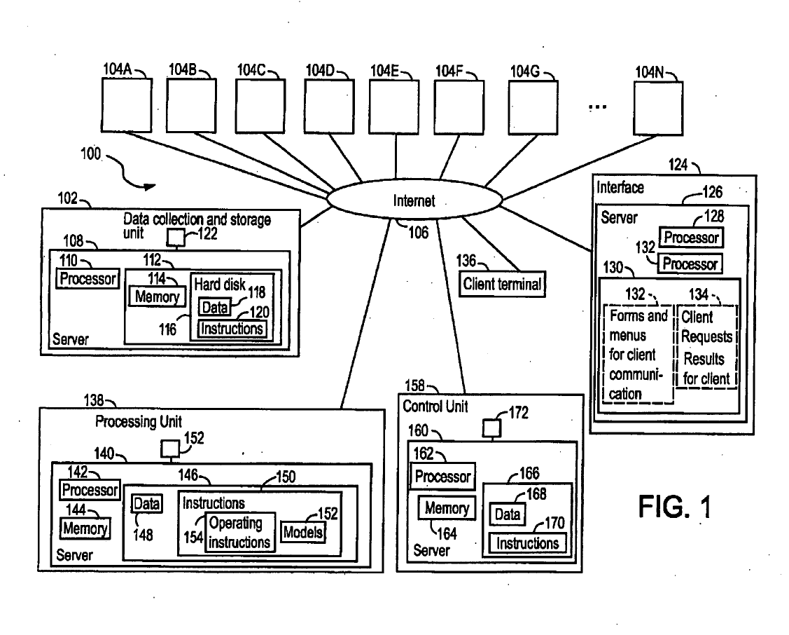

FIG. 1 illustrates a mortgage analysis and forecasting system 100 according to an aspect of the present invention. The system 100 comprises a data collection and storage unit 102, which receives data from a number of sources 104A . . . 104N. The unit 102 may comprise an automated data processing device or collection of devices such as a server and appropriate communications interface. The unit 102 may alternatively comprise a data collection and assembly organization staffed by human operators, suitably using automated equipment to assist in data collection and storage. The data sources may include government services, commercial subscription services, information collected during the conduct of transactions by entities by or for whom the system 100 is operated, or any other sources of data that can be analyzed to aid in decisions relating to marketing and providing of mortgage services.

One particularly useful category of data comprises data collected by the U.S. government under the Home Mortgage Disclosure Act (HMDA). HMDA requires each provider of mortgage financing to furnish information about its applicants and successful borrowers. For each mortgage application, a provider supplies its own identification, the census tract in which the subject property is located, the type and purpose of the loan, the occupancy of the property, for example owner occupancy or rental, the loan amount, the action taken on the loan, the race, gender and income of the applicant and co-applicant, if any, the type of purchase and the reason for denial, if any.

In addition to using the information to inform governmental decisions, the U.S. government also distributes statistics drawn from the information to interested parties. Statistics drawn from information collected under HMDA are useful in analyzing mortgage demand and activity in a region and identifying and the mortgage financing needs of the region and population groups within the region and the extent to which those needs are being met. Regions may include user defined market regions, census tracts, metropolitan areas, counties, states, the nation as a whole, or any other predetermined area or region of interest from the point of view of evaluating a marketing or business opportunity related to mortgage financing.

Thus, the data source 104A may suitably be a provider of statistics drawn from HMDA information, whether the provider is the U.S. government itself, an information compiling HMDA data, or an organization within an entity by or for which the system 100 is operated. Other data sources may include the data source 104B, which may suitably be a subscription service providing economic data and forecasts for various communities and regions. The data source 104C may be a trade organization information service providing information about housing sales and prices. The data source 104D may be a source providing credit analyses for populations in various geographic areas. The data source 104E may be a source providing analyses and projections of health care expenses. The data source 104F may be demographic data, such as census data, provided directly by the U.S. government or by a commercial source which further analyzes and develops such data. Census data is particularly useful in evaluating population growth and homeownership patterns in a region. The data source 104G may supply economic and employment data provided by the U.S. government or some other provider. The specific examples listed here are just a few possibilities, but it will be recognized that numerous possibilities exist for data sources, and numerous sources may be used to take into account a wide variety of types of data. The various data sources may communicate with the data collection and storage unit 102 using any suitable technique or medium or combination thereof, but one suitable exemplary medium is the public Internet 106.

The data collection and storage unit 102 may include devices for identification, collection and storage of data, for example a server 108. The server 108 may include a processor 110 and storage 112, with the storage 112 suitably including short term memory 114 and long term storage such as a hard disk 116. The hard disk 116 may store collected data 118, and may also host instructions 120 for execution by the processor 110. The instructions may include, for example, instructions 120 identifying data to be collected, such as explicit instructions to collect specified data or a schedule for periodic collection of data from specified sources. The server 108 may also include a user terminal 122, to allow for control by an operator.

The data collection and storage unit 102 also communicates with an interface 124. The interface 124 may take the form of systems and procedures for conducting of communications with a client, for example by human employees of an operator of the system 100. Alternatively or in addition, the interface 124 may include a server 126, comprising a processor 128 and one or more storage devices such as memory 129 and a hard disk 130. The hard disk 130 may host instructions to be executed by the processor, for example instructions 132 for the presentation of forms and menus for entry of data and instructions, for example by a client or employee of a client or by an employee of the entity operating the system 100 on behalf of a client. The forms and menus may comprise forms directing presentation of instructions by a user, so that a user makes selections and provides information specifying the information needed or the questions to be answered. The forms and menus may further comprise standardized forms presenting results to the user. The hard disk 130 may also store data 132, such as client requests and results that have been prepared for presentation to the client. The interface 108 may allow for operation by one or more employees of an entity operating the system 100, and may also be designed to allow direct communication by a client employee using a client terminal 136, for example using the Internet 106 as a communications medium.

The interface 124 allows a client for whom a set of recommendations is being developed to choose options defining the analysis and recommendations to be provided. The interface 124 suitably presents a menu of options allowing the client to designate the analysis to be performed and categories of information to be provided. For example, a client may be particularly interested in factors relating to homeownership demand and may therefore choose an analysis that includes detailed information relating to population growth, homeownership demand, housing prices and the like. Another client may be interested in factors involved with a risk of default and may therefore choose to receive and analyze information such as statistics relating to personal bankruptcies and unemployment rate trends. The interface 124 may also provide for submission by the client of information useful in performing an analysis. For example, a large client may have a substantial amount of transaction information available, which can be used to develop statistics for one or more areas. As another example, a client may have multiple offices and may wish to know which offices to expand or reduce. The interface 124 may be used to receive information from a client to the offices, for example their locations, their territories of coverage and their costs of operation.

The system 100 further includes one or more processing units such as the processing unit 138, which retrieves stored information, for example information stored by the unit 102. The unit 138 may comprise a processing center staffed by human operators or alternatively or in addition may comprise an automated data processing device or collection of devices. A suitable combination of devices for use in the processing unit 138 includes a server 140, including a processor 142, memory 144 and long term storage, such as a hard disk 146. The hard disk may suitably store data 148 and instructions 150. The data may include date collected from the data collection and storage unit 102, intermediate processing results and/or final results to be delivered to the interface 124 for formatting and presentation to a client. The instructions may suitably include operational instructions 152, either previously created and stored or else constructed in response to a client inquiry or other occasion calling for analysis, and models 154 to be used in analyzing data and producing results. The server 140 may suitably include a user terminal 156. The unit 138 may suitably communicate with other elements of the system 100 through suitable communications media, such as the Internet 106 or other appropriate media.

Data retrieval and processing may be conducted under the control of a separate control unit 158, which may use general rules of operation as well as specific client requirements to identify categories of data required and the data sources providing the data, and techniques to be used in analyzing the data. The unit 158 may comprise a processing center staffed by human operators or alternatively or in addition may comprise an automated data processing device or collection of devices. A suitable combination of devices for use in the processing unit 158 includes a server 160, including a processor 162, memory 164 and long term storage, such as a hard disk 166. The hard disk may suitably store data 168 and instructions 170. The data may include stored data related to client inquiries or other information requests or requirements. The instructions 170 may suitably general predetermined operational parameters and requirements, for example general instructions relating to the use of specific categories of data and identifying specific categories of data with categories of inquiries. The instructions 170 may also include various sets of instructions for answering particular inquiries. The instructions 170 may further include specific sets of instructions created by the unit 158 in response to identification of processing needs, such as a client request delivered through the interface 124 or some other indication of a need for information to be delivered or questions to be answered. The server 160 may suitably include a user terminal 156. The unit 158 may suitably communicate with other elements of the system 100 through suitable communications media, such as the Internet 106 or other appropriate media.

The control unit 158 receives client instructions and data from the interface 124 and uses the instructions and data to define the information and recommendations required. The control unit 158 then suitably builds a set of data retrieval and processing instructions directed toward producing the desired information and recommendations. Instructions may designate the data to be gathered, the sources from which the data is to be gathered, models to be constructed to analyze data, steps to be taken to process data using models and other techniques, and any other suitable instructions for actions to be taken to provide the needed information.

Once the set of data retrieval and processing instructions has been established, the control unit 158 directs the activities of the various other units according to the instructions. Typically, the control unit 158 first directs the data retrieval and storage unit 102 to retrieve appropriate data for processing. The unit 102 may interrogate appropriate ones of the data sources 104A . . . 104D in order to obtain appropriate data. In addition, or as an alternative, the unit 102 may periodically receive data from one, some or all of the data sources 104A . . . 104N and store the data for later use. When the data is required for processing, it is retrieved from storage.

Once appropriate data has been retrieved, the data is delivered to the processing unit 138 by the data retrieval and storage unit 102. The processing unit 138 uses the processing instructions to define processing to be performed on the data.

One broad class of information that may be generated and presented by the system 100 is comparative statistical data for various regions, such as metropolitan areas. Comparative statistics for designated categories of information may be presented for selected regions. For example, a plurality of geographic areas may be selected, such as a list of geographic areas selected by a client, or a selection having specified characteristics, such as the largest 25 standard metropolitan statistical areas (MSAs) in the United States. Data for specified categories of information may be presented for the specified geographic areas.

One possible use of the system 100 is to allow the client to receive desired information relating to specified geographic areas. Thus, the interface 124 suitably presents a variety of information categories to the client for selection. Particularly useful categories of information include current and projected mortgage originations, current and projected change in employment, current and projected unemployment rate, current and projected personal income growth, current and projected population, current and projected prices of existing homes, current and projected net migration of population, current and projected personal bankruptcies, current and projected median and average income, Fair Isaac Company (FICO) score distributions, cost of doing business, cost of living, employment growth, top employers, leading industries, percentage of renters in geographic regions and population groups within the regions, and other suitable categories of information that may be useful to inform client activities related to the mortgage finance business.

Such items of information can be evaluated to provide valuable information relating to risks and opportunities presented in a region. If desired, a client may choose categories of information to be presented for specified regions, or may chose to see information for categories of regions, such as the 25 largest regions.

Alternatively, geographic areas meeting specified criteria may be selected and presented. A client may provide selections relating to categories of data, such as a desire to see areas with a specified rate of housing price increases, a specified rate of population growth, or similar selections.

As a further alternative, the client may simply present generalized selections. For example, a client may desire information relating to the advisability of expanding a mortgage lending operation in a particular area, or may desire to know which geographic areas can be expected to present strong demand, low risk, or low cost of operation. Statistical factors relevant to such requirements are identified and data is gathered and processed in order to determine values for the statistical factors. The statistical factors are then evaluated and compared for various geographical locations and geographical locations meeting the client's requirements are identified and presented. In addition, appropriate details and highlights of the statistical factors that led to the identification of the geographic locations are suitably presented.

In order to use statistical data to identify geographic areas meeting client requirements, the processing unit 138 may suitably develop models relating the statistical data to the requirements. For example, projected mortgage originations for an area are highly relevant to demand for mortgage services in the area. Models may be developed using past and current rates of mortgage originations to project future rates. Often, data for present and projected numbers of mortgage originations for some areas, such as large metropolitan statistical areas are directly available for purchase from data vendors. Such data may not be available for other areas, such as smaller areas. One suitable technique for determining projected originations for an area of interest is to examine data for previous years and use appropriate statistical techniques, such as linear regression, to calculate a trend. Carrying the trend into the future can yield data for desired future years. For example, an analysis carried out over three previous years may indicate a linear 10% rate of increase in originations, and projection of this trend into the future indicates that the following year will exhibit a 10% increase over the current year, that the second succeeding year will exhibit a 21% increase over the current year, and so on.

As an alternative to computing projected values, it is often possible to purchase projected data directly from vendors. Projections may be available for purchase only for larger areas, and modeling techniques may be used to make projections for areas for which projections cannot be purchased. For example, if a projection is to be computed for an area for which projected data is not available for purchase, the nearest larger area may be identified and the trends for the larger 10 area computed. The trends for the larger area may be applied to the current data for the smaller area to obtain projected data for the smaller area.

One frequently used way to identify mortgage originations is to separate originations into retail/wholesale originations and correspondent originations. If projections are available for total originations, the same rate of growth may be used to project retail/wholesale and correspondent originations.

Such models, or alternative models, may employ additional factors to estimate mortgage demand. For example, statistical factors relevant to a high demand for mortgage services include a growing population, growth in available housing, growth in employment and rising personal income. A trend of rising interest rates may tend to depress the growth rate of mortgage originations below that otherwise projected, and to shift the proportion of originations between purchase transactions and refinance transactions. A trend of falling interest rates may tend to increase the growth rate of originations above that otherwise projected, and to shift the proportion of originations between purchase and refinance transactions. These and other appropriate factors can be used to refine calculations of projected mortgage originations based on current and future rates, or can be used independently to develop other suitable measures of mortgage demand.

Additional factors may be considered in evaluating opportunities. For example, repayment risk is relevant to evaluation of opportunities presented by a region. Factors relevant to a relatively low risk in providing mortgage services include projections of rising personal income, increasing housing prices, a stable or decreasing unemployment rate and a relatively low and stable or decreasing rate of personal bankruptcies. Models are developed correlating appropriate groupings of factors with desired information. Data relating to the statistical factors is retrieved and then processed using the models.

For example, a risk score may be used to identify the risk of loss associated with mortgage lending activities in a region. The risk score may be developed using a model incorporating factors such as employment growth, income growth, housing price trends, personal bankruptcies, housing affordability, with housing affordability being a finction of home prices and median income for a region, and other suitable factors. A model may be created using appropriate relationships between the various factors, and when data for a particular region is to be evaluated, data is collected for the region and appropriate data for the statistical factors is provided as inputs to the model in order to compute a risk score for the region. Other models may be used to determine cost of doing business, cost of living and other relevant data items.

Particularly important considerations in evaluating different regions are a client's performance in emerging markets in the region. These markets include population groups, such as particular ethnic groups or income groups, age groups or groups defined by family structure such as single persons, childless persons or persons with children, in which a client's performance is below its potential. Underperformance may represent a lower performance by a client than by the client's peers, or may represent a performance by the client, or by all providers, that is lower than the potential represented by the market. Recognizing underperformance allows the client to deploy additional resources, or to otherwise alter its practices, in order to achieve a performance nearer to its potential.

In order to identify population groups as emerging markets and to determine performance in the population groups, the system 100 suitably employs the data collection and storage unit 102 to obtain data pertaining to the service being received by the market, as well as data pertaining to the potential represented by the market. One particularly important data item in considering the degree to which a market is being served is the number of mortgage originations in that market. One useful source of data for mortgage transaction information, including the population groups being served, is HMDA data. Additional relevant information includes economic information and census information, in order to evaluate income and housing patterns among population groups in the area.

The unit 102 therefore suitably retrieves HMDA data from the data source 104A, economic data from the data source 104B and census data from the unit 104F. The processing unit 138 identifies data relating to the region and the population groups under examination. The processing unit 138 processes the data to determine the potential represented by each population group. The processing unit 138 then examines relevant data to determine the extent to which the client is serving the market. This data may be included in HMDA data, or may be supplied by the unit 102 after retrieval from another source, such as internal data relating to the client's operations. The processing unit 138 then evaluates the client's performance with respect to its potential. The evaluation may be performed with respect to the client's competitors or with respect to the potential represented by the market, depending on client selections. The evaluation results may then be used as desired. For example, data may be presented showing locations in which the client is operating, with data for the performance of the client, performance of competitors, the potential of the market and the client's performance with respect to its competitors and to the potential market, or any other desired selection of such data. Alternatively, or in addition, locations and markets in which a client is underperforming may be identified and identification of the locations and markets, along with comparative data, may be presented.

Suppose that a client wishes to examine population groups in an area in terms of growth potential and risk by comparing the potential presented by each population group and the risk associated with the area, and examining the client's performance to determine if it is achieving its potential in the population group. The client presents its preferences using the interface 124. The preferences may suitably be selected from a menu or other interface serving to assist in defining choices. Alternatively, the preferences may be more broadly presented by the client, with the client's desires being defined through consultation with human staff members. To take an example, a client may wish to examine information relating to a particular metropolitan area, and may wish to receive comparative information relating to the potential for growth in original mortgages, the risk associated with activities in the area, and the extent to which the client is underperforming its potential among emerging markets in the area, with the underperformance evaluated both against the client's competitors and against the overall potential exhibited by the markets.

The client preferences are supplied to the control unit 158 and the control unit 158 identifies the categories of data needed to provide the desired results for the client. The control unit passes this information to the processing unit 138. The processing unit 138 then interrogates the data collection and storage unit 102 in order to obtain the appropriate data to be used to generate the needed results. The data collection and storage unit 102 retrieves data in the selected categories. In the present exemplary case, the unit 102 may examine HMDA information received from the source 104A and apply appropriate filters to extract the needed information. For each metropolitan area, the unit 102 assembles data relating to current mortgage originations in the area. Data available includes breakdowns of originations by race, gender and income of applicant and co-applicant. Other information available relates to property prices and loan amount, types of purchases, and property locations. Additional information collected from other sources, such as the economic data from the source 104B, includes projections of future trends, such as projections of loan originations in each area. Still further data includes economic and demographic statistics for each area, such as census data from the source 104F. The data relating to a population group and an area can be examined to obtain information indicating current and future income, current and future housing prices, current and future employment growth, current and future unemployment and current and future rates of bankruptcy.

Further data includes data relating to the client's performance in each region. This data includes loan originations by the client and loan originations by the client's competitors. Additional data includes the percentage of renters versus homeowners. Statistics are obtained both for the population group as a whole and, to the extent possible, for elements of the population group, such as particular ethnic groups. Collection of statistics for ethnic groups helps to determine the potential represented by the groups and to evaluate the client's performance against that potential.

Once the desired information has been assembled, it is passed to the processing unit 138 as needed, and analyzed. The processing unit 138 may employ the data in models, either previously created or created as needed to produce the information required by the client. Models may be created to determine potential homeownership demand for the overall population of an area and for various ethnic and income groups, and to determine lending risk. In order to determine potential homeownership demand, a model is created using percentage of the population group renting versus owning, housing prices, income and income growth, housing affordability and other relevant factors. The model weights the various elements appropriately and statistical data relating to population groups under consideration is used as inputs to the model. A result indicating potential homeownership demand is generated. This result may be compared against the actual homeownership among the population group. If the homeownership demand is below its potential, efforts to market and provide mortgage services to the population group may prove highly beneficial.

Models may be created to assist in evaluating risk, including a model for determining a risk score as discussed above. Data for a geographic area may be used as an input to the model, and the evaluation of risk generated by the model may then be used to evaluate the desirability of promoting services in the area. After evaluating the various geographic areas and population groups, areas and population groups exhibiting potential growth are identified to the client and relevant information about the areas and population groups is presented.

In the present example, in addition to the overall potential of areas and population groups, the client's performance is compared against that of its competitors. The unit 102 identifies each loan origination performed by the client with an area and population group, and also obtains data for loan originations performed by the client's competitors and examines this data to identify areas and population groups associated with the loan originations. This data may, for example, be obtained by examining HMDA data. The processing unit 138 then evaluates the client's performance against that of its competitors.

Once the performance of the client and its competitors and the potential of the various areas and markets have been evaluated, the processing unit 138 supplies the evaluation results to the interface unit 108. The interface 124 prepares the results for presentation to the client and presents them for presentation to the client in a suitable format. In the present exemplary case, the presentation may include one or more spreadsheets listing the metropolitan areas examined along with data for each area. For example, a spreadsheet may be prepared listing the various metropolitan areas. The name of each area may be listed, and each may be accompanied by data relating to the potential and servicing of the Hispanic population group in the area, together with other relevant information relating to the population group and the client's performance with respect to the population group, such as the client's performance against its competitors. Other spreadsheets may show results for other population groups in the selection of metropolitan areas, as well as results for the overall population groups in the selected geographic areas. The client is able to manipulate the spreadsheets as desired to provide a desired view of information, for example sorting and filtering to highlight desired criteria. Numerous additional or alternative presentations are possible, such as charts or slides presenting significant information, lists of desirable areas or population groups suitable for expansion of activities or other desired forms of presentation.

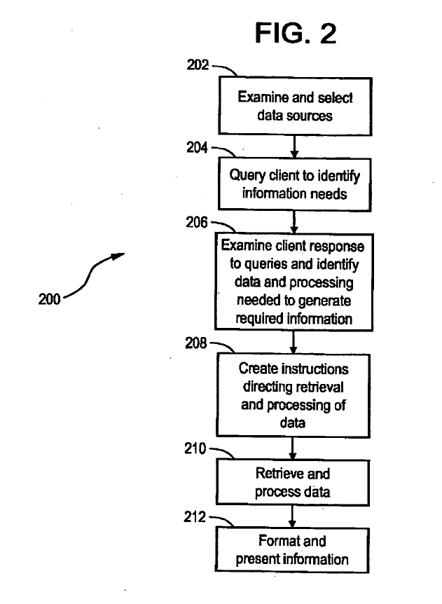

FIG. 2 illustrates the steps of a process 200 of mortgage opportunity information collection and analysis according to an aspect of the present invention. The process 200 may be carried out using a system such as the system 100 of FIG. 1, or by any other suitable means. For example, suitable data may be manually collected and entered into a computer database or stored in a suitable form of electronic memory. That data may be retrieved as needed by a suitably programmed processor and processed as taught herein using a MICROSOFT® EXCEL® spreadsheet or the like to provide an output for display, print or other presentation. At step 202, various data sources providing information relevant to identifying and exploiting opportunities, risks and cost of marketing and providing mortgage services are examined and selected and suitable arrangements made for retrieving needed data from the sources. Relevant data includes demographic and economic data for regions and population groups, and includes population and population trends, employment and employment trends, housing prices, homeownership versus renting, income and income trends, bankruptcies and numerous other data elements relevant to determining demand for and availability of homes, and the ability of residents of a region or members of a population group to pay for the housing available in the region.

Sources of data include numerous commercial, governmental and other sources of data, such as sources of HMDA data, sources of projected economic data Sources may include commercial, government or other sources and may include information related to transactions and operations or transactions carried out by a client or other entity having an interest in receiving analyses showing opportunities for marketing and providing of mortgage services.

At step 204, a client is queried to identify its information needs. Querying may include providing the client with an automated menu of categories of information to be provided, such as demographic and economic data for specified regions, identification of regions meeting specified criteria and presentation of information about those regions, or answers to generalized questions, such as identification of regions and population groups for which the client is performing at less than its potential. Numerous other techniques for querying the client may be contemplated, such as providing human staff to consult with the client, providing a questionnaire and examining and interpreting the responses or other suitable techniques. At step 206, the client's responses to queries are examined to determine its needs for information and identification of the data and processing required to supply that information are defined. At step 208, a set of instructions is prepared directing retrieval and processing of data. The instructions may include gathering and assembly of data, identification or generation of models to be used to project future trends or events or to develop information and comparisons from statistical data. For example, models may be used to evaluate market potential, risk, cost of living, cost of doing business and other factors useful for evaluating the desirability of marketing or providing services in an area. Required data may be retrieved from data previously stored and collected, or may be gathered as needed, depending on previous and available arrangements for gathering of data.

At step 210, data needed to generate the information required by the client is retrieved and processed as needed to generate the required information. At step 212, information meeting the client's requirements is formatted and presented.

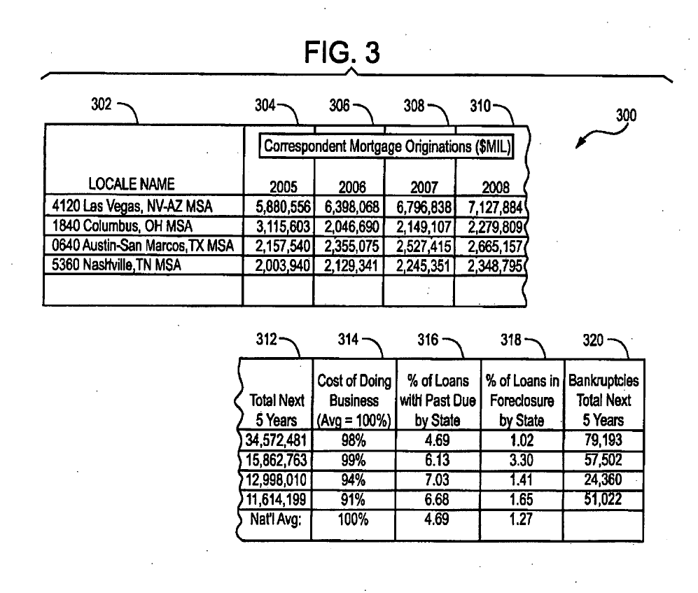

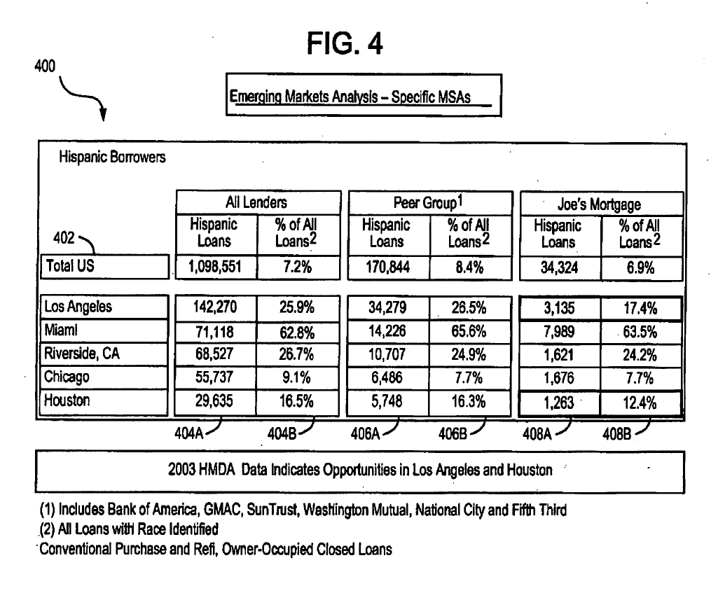

In addition to the examples discussed above, numerous possibilities exist for collection of data and development and presentation according to an aspect of the present invention. Geographic areas may be ranked by opportunity, risk and cost of doing business, FIGS. 3 and 4 illustrate exemplary presentations of information, suitably developed using the systems and techniques of the present invention.

FIG. 3 illustrates a table 300 presenting comparative data for different metropolitan areas. The table 300 includes columns 302-320. The column 302 identifies four metropolitan areas by name, specifically Las Vegas, Columbus, Ohio, Austin, Tex., and Nashville, Tenn. For each area, columns 304-310 present correspondent mortgage origination values for 2005, 2006, 2007 and 2008, respectively. Column 312 presents the total projected correspondent originations over the next five years. Columns 314 and 316 present the percentage of loans in a past due state and in foreclosure, respectively. Column 318 presents the cost of doing business as a percentage of the nationwide average and column 320 presents the projected total bankruptcies over the next five years. An examination of the data presented shows that the Las Vegas area presents the prospect of a very high volume of business, with a competitive cost of doing business and past due and foreclosure rates lower than the other regions.

FIG. 4 illustrates a chart 400 comparing a client's performance among Hispanic borrowers in five metropolitan areas. The column 402 identifies the metropolitan areas as Los Angeles, Miami, Riverside, Calif., Chicago, and Houston. Column 404A shows the total loans to Hispanic borrowers and column 404B shows the percentage of all loans made to Hispanic borrowers among all lenders. Columns 406A and 406B show the total and percentage of loans to Hispanic borrowers among the client's peer group and columns 408A and 408B show the total and percentage of loans to Hispanic borrowers by the client. An examination of the data shows that the client is underperforming its peer group in Los Angeles and Houston, raising the possibility that opportunities for expansion of the client's business exist with respect to serving the Hispanic population group in these areas.

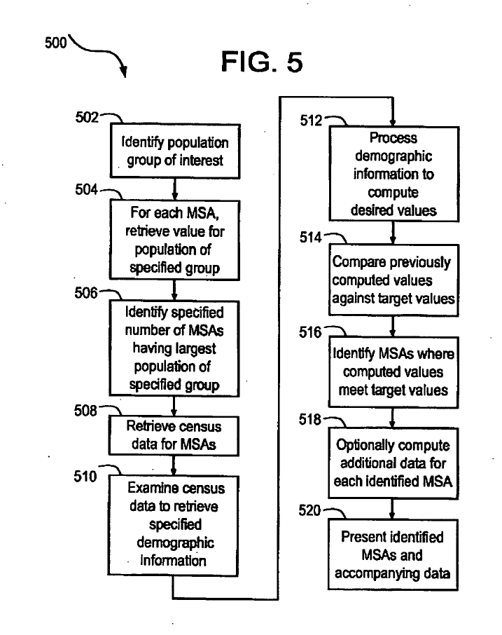

FIG. 5 illustrates the steps of a process 500 for identifying areas in which a specified population group is underserved and therefore represents potential opportunities. The process 500 may be thought of as a specific example of the application of the process 200 to answer a specific question, and may be implemented using a system such as the system 100 of FIG. 1. At step 502, a population group of interest is identified. In the present exemplary case, the population segment is African Americans. At step 504, the population of African Americans in each metropolitan statistical area (MSA) is retrieved. At step 506, a specified number of MSAs with the largest populations of the specified group, in this case the largest African American populations, are identified. A convenient number of MSAs is 50 to 100. At step 508, U.S. census data for the identified MSAs is retrieved. At step 510, the data for each MSA is examined to obtain specified demographic data for each MSA. In the present example, the data is examined to determine the number of households of the specified group, the median household income among households of the specified group, the number of renting households among households of the specified group, the size of the population of the specified group within an age range associated with high home buying demand, in the present case 25-54, and the median home price in the MSA. At step 512, the data is processed to compute desired values. In this case, the desired values are the percentage of renting households among the specified group, namely the African American population, and the affordability ratio of houses within the MSA for the specified group, namely the African American population group. The affordability ratio of houses for a population group may suitably be computed by dividing the median house price for an area by the median household income for the population group. At step 514, previously computed values, in this case the percentage of renting households and the affordability ratio, are compared against target values. At step 516, MSA for which the percentage of renting households and the affordability ratio meet the target values are identified for consideration. In the present case, the criterion for meeting the target values is equaling or exceeding the target values. At step 518, additional data is optionally computed for each area. At step 520, the identified MSAs and relevant data is formatted and presented. The data may be sorted as desired, such as by population of the specified population group, or alternatively or in addition, the presentation of the data may include facilities for sorting and filtering data as desired.

It will be recognized that numerous different population groups may be evaluated using techniques similar to that described above, such as the overall population for an area, single men or women, childless families, families with children, or any other group that may be of interest. It will also be recognized that different age ranges may be used as defining high homebuying potential and that age ranges may also be used to define population groups of interest.

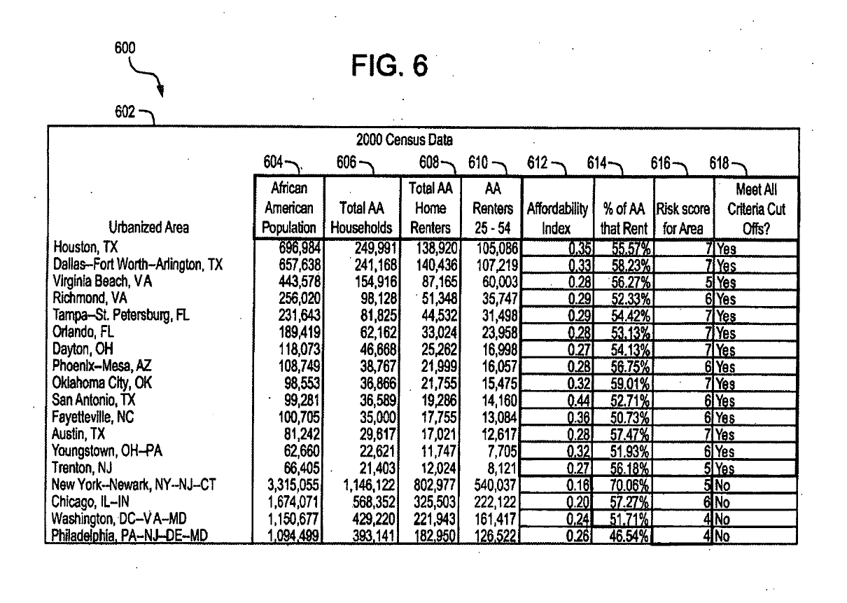

FIG. 6 illustrates a chart 600 presenting data relevant to understanding the overall potential presented by the African American population group in a number of different urbanized areas. The chart 500, or similar charts, may be generated using the process 500 illustrated in FIG. 5 and described above.

The column 602 identifies the areas, and columns 604-618 present data for each area. Columns 604 and 606 present the total African American population group and total African American households, respectively, for each area. Column 608 presents the total number of African American renters and column 610 presents the total number of African American renters between the ages of 25-54. Traditionally, homeownership demand is highest among people in this age range. Column 612 presents an affordability index value for each area, column 614 presents the percentage of African Americans who rent and column 616 presents a risk score indicating an evaluation of relative risk for each area. The risk score is calculated based on various economic factors and falls within a range of 1 to 10, with 1 representing the lowest risk and 10 representing the highest risk. Column 618 indicates whether each area meets all criteria cutoffs. The information presented by the chart 600 is useful in evaluating the potential homeownership demand among the African American population group of each area, and whether that potential is being met.

While the present invention is disclosed in the context of aspects of an embodiment employing a specific system and exemplary web pages, it will be recognized that a wide variety of implementations may be employed by persons of ordinary skill in the art consistent with the above discussion and the claims which follow below.

We claim:

1. A system for identifying opportunities for the marketing and providing of mortgage services, comprising:
a control unit for identifying data needed to provide desired information relating to opportunities for marketing and providing mortgage services and identifying operations to be performed on that data in order to identify and evaluate opportunities for marketing and providing mortgage services;
a data collection and storage unit for retrieving data from one or more of a plurality of sources of demographic and economic data and storing the data using a data storage device; and
a processing unit for receiving data from the data collection and storage unit and processing the data to identify demographic and economic characteristics of regions and population groups and to evaluate the demographic and economic characteristics in order to generate opportunity evaluation information identifying and evaluating opportunities for marketing and providing of mortgage services.

2. The system of claim 1, wherein the control unit creates instructions for data retrieval and operations to generate the desired information and stores the instructions for retrieval and delivery to the data collection and storage unit and the processing unit as needed.

3. The system of claim 2, further comprising an interface for receiving specifications of requirements for information to be generated and passing the specifications to the control unit for use in identifying the data and processing required to generate the information, the interface being further operative to format and present the opportunity evaluation information.

4. The system of claim 3, wherein the interface unit generates and presents forms allowing entry of information defining questions to be answered or opportunity evaluation information required.

5. The system of claim 4, wherein the interface is operative to communicate with a client terminal so as to allow direct input by a client of questions and information requests and direct presentation to the client of opportunity evaluation information.

6. The system of claim 5, wherein the opportunity evaluation information comprises comparative information relating to different geographic regions.

7. The system of claim 6, wherein the opportunity evaluation information comprises information relating to specified population groups.

8. The system of claim 7, wherein generating opportunity evaluation information includes identifying geographic regions based on comparative characteristics of specified population groups within the regions.

9. The system of claim 8, wherein generating the opportunity evaluation information includes evaluating the homeownership demand potential of a population group and comparing the homeownership potential of the population group with actual homeownership among the population group.

10. The system of claim 9, wherein the interface is operative to receive opportunity evaluation information from the processing unit and to format and present the opportunity evaluation information through communication with a client terminal.

11. A method of identifying and evaluating opportunities for marketing and providing of mortgage services, comprising the steps of:
identifying categories of demographic and economic data required to provide desired information identifying and evaluating geographic regions and population groups with respect to opportunities they present for marketing and providing mortgage services and arranging to receive data as needed from one or more data sources supplying such data;
upon receiving requirements specifying desired information to be generated, identifying specific data needed to generate information meeting the requirements and processing to be performed on the data in order to generate the information;
retrieving the identified data and performing the identified processing to generate the information meeting the requirements; and
formatting and presenting the information.

12. The method of claim 11, wherein the step of identifying specific data and processing to be performed on the data is followed by a step of generating and storing instructions directing automated retrieval and processing of data and wherein the step of retrieving the identified data and performing the identified processing comprises following the instructions so as to perform automated processing as directed by the instructions.

13. The method of claim 12, wherein the requirements include answers to generalized questions relating to opportunities for marketing and providing mortgage services.

14. The method of claim 13, wherein desired information includes evaluation of potential opportunities among population groups and wherein identifying, retrieving and processing data includes retrieving demographic and economic data relevant to the potential homeownership demand of a population group and evaluating the extent to which unmet demand is present in the population group.

15. The method of claim 14, wherein evaluating the extent to which unmet demand is present in a population group includes selecting and processing demographic and economic data to generate an indication of the potential demand presented by the market and comparing the potential demand with the actual homeownership among the population group.

16. The method of claim 15, wherein evaluating the extent to which unmet demand exists in a population group includes evaluating a mortgage provider's performance among the population group relative to its competitors.
